(19) United States
(12) Patent Application Publication
(10) Pub. No.: US 2006/0182425 A1
(43) Pub. Date: Aug. 17, 2006

(54) Converting a still image to a plurality of video frame images

(76) Inventors: Paul Boerger, Loveland, CO (US); Philip M. Walker, Fort Collins, CO (US); Samson J. Liu, Monlo Park, CA (US); Peng Wu, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/057,272

(22) Filed: Feb. 11, 2005

(51) Int. Cl. H04N 5/225

(52) U.S. Cl. 386/120

(57) ABSTRACT

A method of viewing a file comprises causes the file to begin playing and, after causing the file to begin playing, converts a still image from the file into a plurality of video frames to form a video clip.

### BACKGROUND

Electronic “slide shows” comprise a valuable mechanism for conveying information. Software exists that permits a user to create individual slides (termed generically herein as “still images”) to include within a slide show to be shown on a display in a prescribed order. Effectively playing a still image-based slide show on a system designed for playing a video source is problematic.

### BRIEF DESCRIPTION OF THE DRAWINGS

For a detailed description of exemplary embodiments of the invention, reference will now be made to the accompanying drawings in which:

FIG. 1 illustrates an embodiment of a slide show playback system consistent with the present invention;

FIG. 2 shows an embodiment of an optical disc player;

FIG. 3 shows a method embodiment;

FIG. 4 illustrates the effect of the method embodiment of FIG. 3 on an exemplary slideshow; and

FIG. 5 illustrates an exemplary association of an audio stream with a video stream.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The terms “video sequence” and “video clip” are synonymous as used in this disclosure.

### DETAILED DESCRIPTION

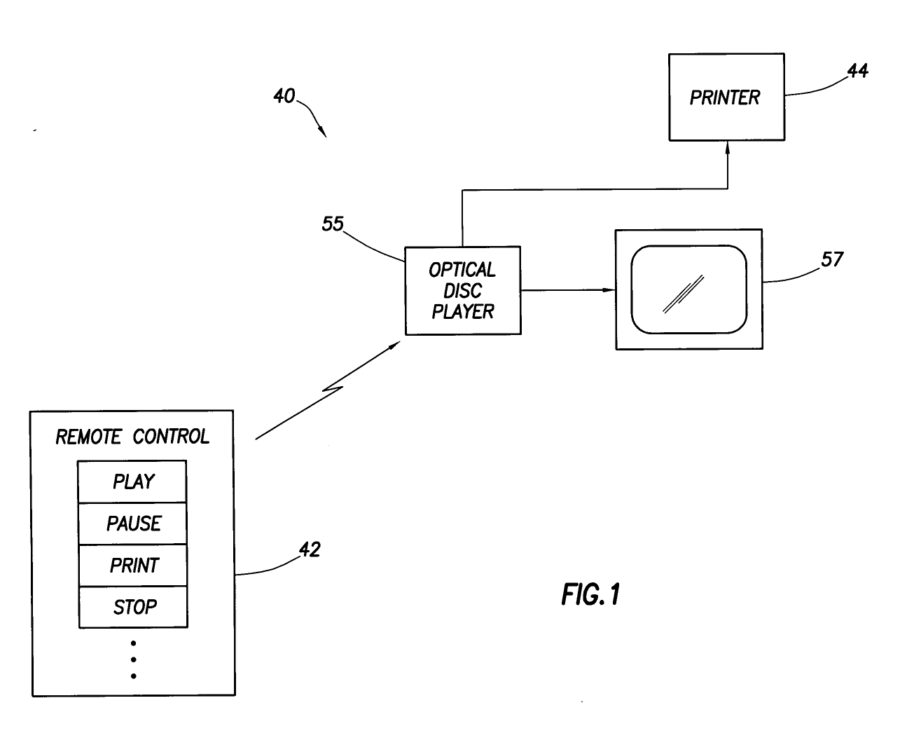

FIG. 1 shows a system 40 comprising an optical disc player 55 operatively coupled to a printer 44 and display 57. The printer 44 may connect to the optical disc player 55 (as shown in the exemplary embodiment of FIG. 1). In other embodiments, the printer may connect to the display 57 or to a network to which the optical disc player also connects. A wireless remote control device 42 can be used to permit a user to control the operation of the player. The display 57 may comprise a television, computer monitor or other suitable display device. The optical disc player 55 receives an optical disc on which a slide show or other type of file containing still images has been stored. The optical disc player 55 plays the slide show on the display 57 as described herein. In other embodiments, other types of storage devices such as flash memory, hard disk drive, etc., can be used instead of an optical disc storage medium.

The term “slide show” is broadly used herein to refer to any sequence of images to be displayed on a playback system, such as that of FIG. 1. In general, a slide show comprises a series of still images. Each still image may comprise text, graphics, photographs, or combinations thereof.

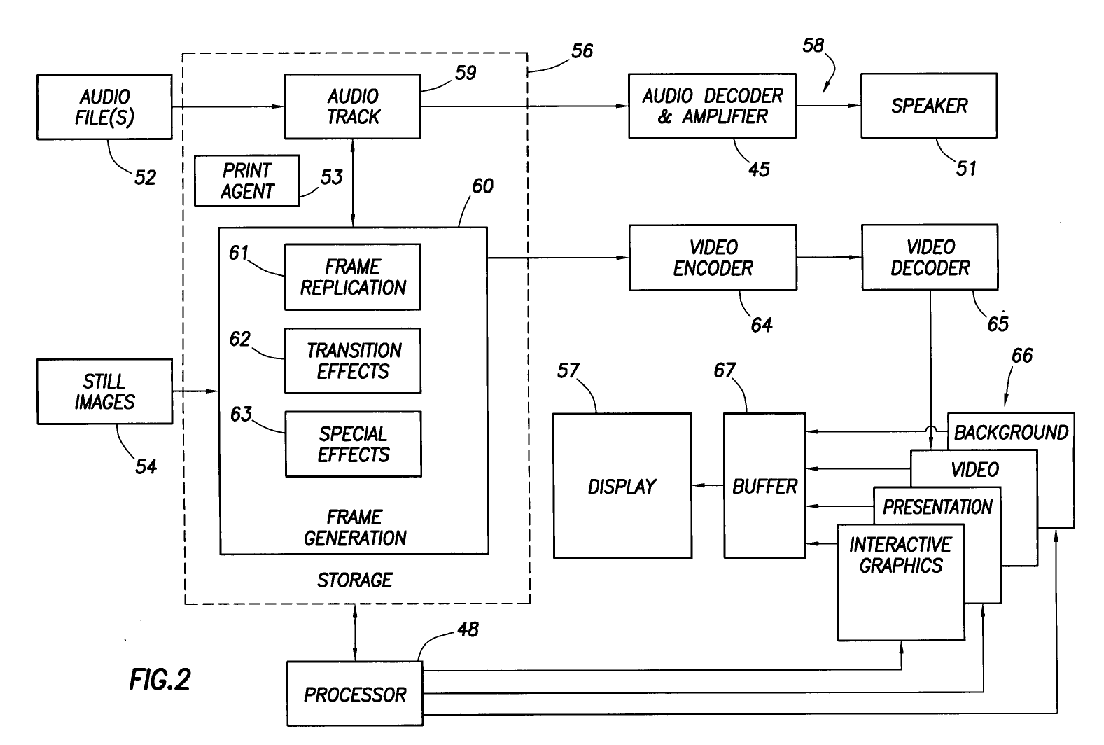

FIG. 2 shows an exemplary implementation of the optical disc player 58. The optical disc player comprises a processor 48, storage 56, a video encoder 64, and a video decoder 65. A speaker 51 and an audio decoder and amplifier 45 may also be included for playing audio. The storage 56 comprises one or more executable applications such as audio track software 59 and frame generation software 60. The frame generation software 60 comprises a frame replication module 61, a transition effects module 62, and a special effects module 63. These software modules are executed by processor 48. The storage 56 may be implemented as a combination of volatile and/or non-volatile storage such as random access memory, read only memory (ROM), flash ROM, hard disk drive, etc.

Still images 54 from a slideshow file are provided as an input to the frame generation software 60 (understanding that frame generation software 60 is software executed by a processor, the processor 48 in the embodiment of FIG. 2). The frame replication module 61 converts at least one, and in some embodiments all, of the still images 54 into a video sequence. In some embodiments, this conversion process comprises replicating each still image to generate enough video frames so as to create a video clip. If desired, transition and special effects can be imposed on the video sequence during the video still-to-video sequence replication process.

Once the video sequence is created, the video encoder 64 encodes the video sequence. The video decoder 65 decodes the video sequence to play back on the display 57. In accordance with embodiments of the invention, information provided to the display is represented as a combination of one or more planes 66. Each plane generally serves a different purpose. In the exemplary embodiment of FIG. 2, four planes are used—a background plane, a video plane, a presentation plane, and an interactive graphics plane—as may be characteristic of, for example, a Blu Ray specification. A different number of planes can be implemented in other embodiments. Although these planes are shown in FIG. 2 as components of the optical disc player 58, in general, the planes are data structures that may be stored in storage 56 or elsewhere. An exemplary function of each of the planes 66 is provided below in Table I. In other embodiments, different functions can be attributed to each plane.

TABLE I
Plane Descriptions.

| Plane Name | Description |
|---|---|
| Background Plane | Used to render a background image |
| | such as a solid color. Particularly |
| | useful when the aspect ratio of the slide |
| | show video does not comport with that |
| | of the display surface. |
| Video Plane | Used to render video such as from a |
| | slide show. |
| Presentation Plane | Used to render metadata and |
| | navigation menus. |
| Interactive Graphics Plane | Used to render navigation menus. |

The various planes are combined together and stored in a frame buffer 67 for subsequent rendering on the display 57. In some embodiments, the processor, executing the frame generation software 60, can cause the encoder 64 and decoder 65 to be bypassed and render bit map images directly into the frame buffer 67.

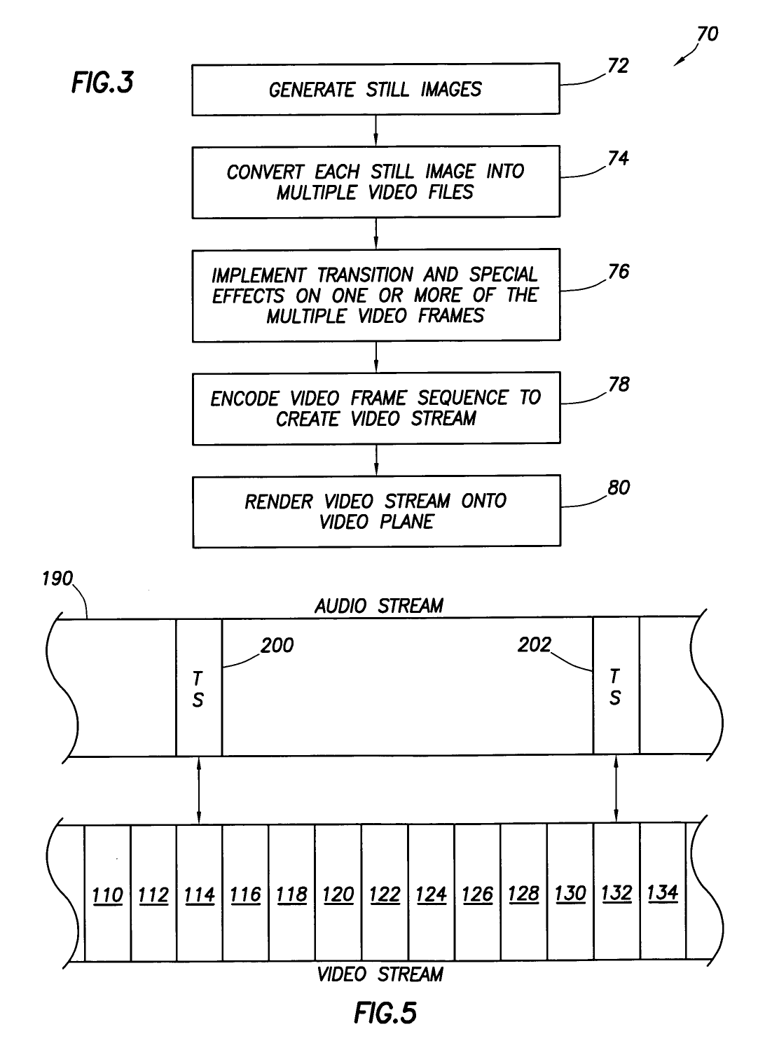

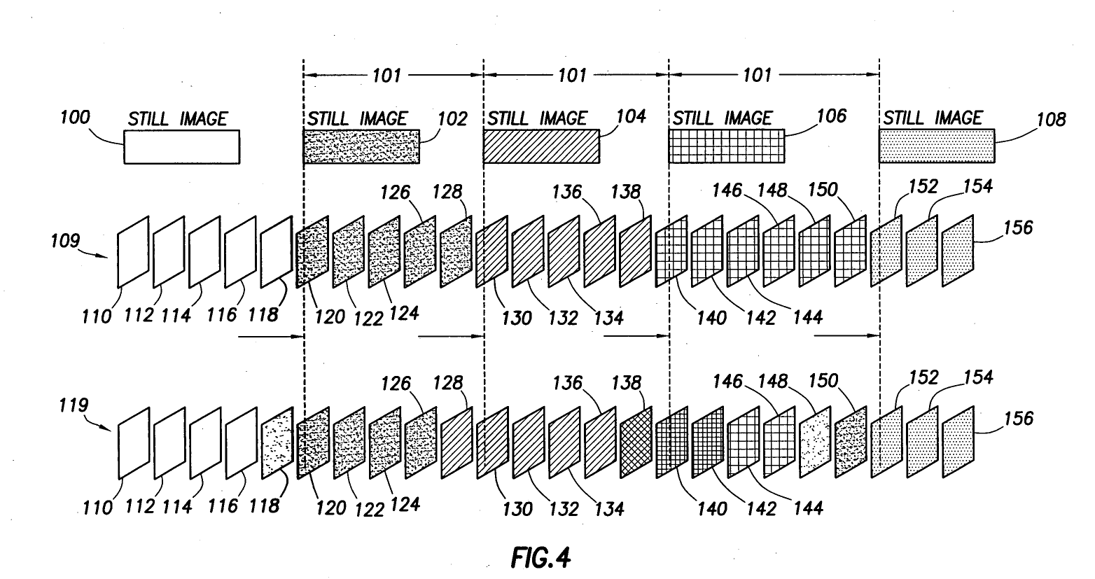

FIGS. 3 and 4 will now be discussed to illustrate the creation of the slide show in accordance with embodiments of the invention. FIG. 3 shows a method 70 comprising actions 72-80. Action 72 comprises generating still images. This action may be performed by any content-authoring software suitable for generating slide shows. Each slide in the slide show may comprise any or a combination of text, graphics, and photographs. In the example of FIG. 4, action 72 results in a series of still images 100, 102, 104, 106, and 108. Each still image broadly represents a single slide within a slide show. As shown, each still image 100-108 comprises different types of shading to depict that each still image may have different information in the slide show.

Some types of slide shows are referred to as “timebased” slide shows in that each slide is displayed for a finite amount of time typically specified by the user. As such, the playback system (e.g., the optical disc player 55) shows each slide for the prescribed time period, then switches to the next slide, and so on. In FIG. 4, the time period for each still image to be displayed is designated by reference numeral 101. The playback system implements a particular video frame rate. The video frame rate refers to the number of video frames that are displayed per second. An exemplary frame rate is 30 frames per second.

In accordance with an exemplary embodiment of the invention, each still image 100-108 is converted (action 74) into multiple video frame images. Further, the conversion of still images to multiple video frames is in accordance with the frame rate of the applicable playback display (e.g., television). In at least one embodiment, the conversion process comprises replicating the associated still image enough times to create a video stream that can be played through the playback system for the desired period of time. If, for example, the frame rate is 30 frames per second and the author of the slide show intends for a particular still image to be displayed for 5 seconds, then the conversion process of action 74 will entail replicating the still image 149 times to thereby create 150 identical frames of that still image. The result of action 74 is depicted at 109 in FIG. 4. As shown, still image 100 is replicated as video frames 110-118. Still image 102 is replicated as video frames 120-128. Still image 104 is replicated as video frames 130-138. Still image 106 is replicated as video frames 140-150, while still image 108 is replicated as video frames 152-156. Of course the number of replicated frames may vary from that shown in FIG. 4 and, in general, will depend on the frame rate as explained above. Pauses can be implemented by suspending the generation of frames.

At 76 in FIG. 3, method 70 comprises implementing transition and special effects (76) on one or more of the replicated video frames. The special effects can comprise any effects now known or later developed such as region scrolling, zoom in/out, wipe, fade in/out, etc. At 119, FIG. 4 illustrates fading into the next still image. For example, video frames 118-122 comprise varying degrees of alteration to fade into the target still image 102 as depicted at frames 124 and 126. The same fade-in process is also performed for frames 128-130, frames 138-142, and frames 148-150. The type of special effect is selected by the author of the slide show and can be varied from still image to still image. Moreover, special effects are imposed directly on the replicated video frames. As such, meta-data (which might otherwise be used to specify special effects) is generally not needed and thus need not be included in at least some embodiments. Further, the playback system need not constructed to interpret meta-data to implement special effects. Instead, the playback system need only play the video stream created in accordance with method 70.

In accordance with at least some embodiments, the conversion of each still image into a video sequence and the implementation of transition and special effects simultaneously occur. In other embodiments, the implementation of transition and special effects occurs after the creation of the video sequence from the still images.

Method 70 also comprises action 78 which comprises encoding the video frame sequence to create a suitable video stream to be provided to the playback system (e.g., on an optical disc). The encoding process may comprise compression and other suitable techniques.

At 80, the method comprises rendering the resulting video sequence onto the video plane described above. With multiple planes on which to render information (e.g., background, video, metadata, navigation menus), additional information can be readily superimposed on the video and a background can be provided on which the video is superimposed.

In accordance with embodiments of the invention, at least actions 74-80 of method 70 is performed “on the fly.” “On the fly” means that the conversion of the still images into a video clip occurs after a user activates the optical disc player 55 to play a selected slide show. In this embodiment, an optical disc contains the slide show in the form of still images. When a user uses, for example, the remote control 42, to activate the playback of the slide show, the optical disc player 55 reads the still images from the disc and performs actions 74-80 at that time. Because the optical disc player 55 is capable of converting a series of still images into a video sequence and creating desired effects on the video clip during playback of the slide show, the video clip need not be stored on the disc itself and need not be created ahead of time. Only the still images version of the slide show need be stored on the disc. Of course, if desired, a persistent copy of the video clip created as described herein can be created ahead of time and stored on the disc. In such an alternative embodiment, the optical disc player need only playback the video clip stored on the disc.

The author of the slide show may desire to have an audio clip play along with the video presentation. The audio may or may not be synchronized to the video frames. Synchronized audio-video means that certain sections of audio are associated with certain still images. Each still image in the slide show has a predetermined presentation timing in a timebased slide show. Synchronized audio permits a user to skip back and forth between still images and have the desired audio segments play in accordance with the particular still images being displayed. Unsynchronized audio means that an audio stream plays while the slide show is being presented, but specific sections of audio are not associated with particular still images. In accordance with embodiments of the present invention, audio can be included with the slide show, in some embodiments in a separate file, and can be synchronized or unsynchronized to the replicated video frames.

FIG. 5 illustrates an audio stream 190 associated with the series of replicated video frames 110-134. One or more timestamps 200 and 202 are embedded within the audio stream 190 to synchronize to the video frames in the case in which synchronized audio is desired to include with slide show. In some embodiments, the audio stream 190 comprises a separate time stamp associated with each replicated video frame. In other embodiments, such as that depicted in FIG. 5, a time stamp is embedded in the audio stream for every n video frames. Time stamp 200 is mapped to video frame 114, while time stamp 202 is mapped to video frame 132. The value n can be set as desired, and in the example of FIG. 5 is 10. Intermediate time values between the time stamps can be computed based on the embedded time stamps and the frame rate associated with the video stream. The special effects module 60 or the encoder 62 maps the audio stream's time stamps 200, 202 to the various associated video frames. This mapping ensures that the playback system plays the correct audio segment while displaying the video frames. Thus, the time stamps are used to associate audio segments with individual video frames, not just the still images from which the video frames were replicated.

Some slide shows are referred to as “browseable” slide shows in that each still image is displayed until a user of the playback system causes the slide show to advance (e.g., by activating a “next” or “back” control). In a browseable slide show, the audio stream may not be synchronized to the various slides and thus the audio is continuously decoded and played, with loops if desired, separate from the decoding and playback of the video stream.

In a browseable slide show, each slide is potentially displayed for an indefinite period of time. That being the case, an issue arises as to which video frame of the multiple replicated frames to “hold” during the potentially indefinite time period. In accordance with an embodiment of the invention, the replicated frame to jump into and hold when the user advances a browseable slide show is predesignated by way of location pointer. For example, if a browseable slide show is playing and is currently displaying and holding on frame 124 in FIG. 4 and the user advances the slide show, a location pointer could be used to point to frame 134 for the next still image. As such, the playback system advances to frame 134 and decodes and holds that frame (i.e., continuously displays that frame until the user again advances the slide show). In some embodiments, the location pointers point to specific portions of the compressed video stream. A decoder in the playback system begins decoding the compressed video stream from that point on. The frame to which the location pointer maps should be “independently” decodable (such as an “I-frame” in accordance with the MPEG protocol). This means that the playback system should be able to decode the identified frame. Some frames (e.g., P-frames and B-frames) may be decodable only based on the decoding of a prior frame. Such frames are not independently decodable.

In other embodiments related to browseable slide shows, a pair of pointers is used with regard to each still image. A first pointer comprises a location pointer into the compressed video stream at which the playback system begins decoding and playing. A second pointer comprises a hold pointer at which point the playback system stops decoding and holds. With reference to FIG. 4, the first and second pointers may point to replicated frames 124 and 128, respectively (or portions of the compressed video stream associated with those frames). As such, the playback system will jump to frame 124, begin decoding from that frame on and stop at frame 128. The playback will hold on frame 128 until the user opts to advance to the next portion of the slide show. Reciprocal pointers can be implemented when reversing back through a slide show.

In some embodiments of the invention, it may be desired to “shuffle” through the slide show jumping from one still image to another in an arbitrary order such as that desired by the viewer of the slide show. To implement shuffling, an embodiment of the invention comprises saving each sequence of replicated video frames for a particular still image as a separate file. For FIG. 4, for example, replicated frames 110-118 can be saved as one file. Frames 120-128 can be saved as another file and so on. The order of the playback of the various files can be specified as desired.

In another embodiment, pointers to a starting point for decoding each series of replicated frames for a still image can be mapped to such frames to provide a mechanism by which to shuffle. Then, the pointers can be listed in a desired to order to implement shuffling during playback of the slide show.

A user of the optical disc player may desire to print an image from the slide show. For example, while viewing the slide show, a user may want to pause the playback and print the image being shown on the display 57. The remote control 42 (FIG. 1) includes a number of buttons such as play, pause, stop, and the like. A print button is also included. When the user sees an image that the user desires to print, the user presses the pause button to freeze the image on the display 57. Then, by pressing the print button, the user can cause the image to be printed on printer 44. The print agent 53 is executed by the processor 48 to implement the print functionality. In other embodiments, the print and pause functions may be invoked by other mechanisms such as pull-down menu items, rather than as dedicated buttons on a remote control.

Because multiple planes are used to render the images on the display 57, the user can cause the image on the display to be printed or any one or more of the various planes to be printed. For example, the user may desire to print only the background and video planes. When the user presses the print button on the remote control 42 (or invoke printing via another mechanism), a menu can be shown on display 57, for example via the presentation or interactive graphics planes, from which the user can select which one or more planes to print. If the user wants to print the amalgamation of all of the planes, the optical disc player prints from the frame buffer 67. As explained above, in embodiments, each of the various planes is maintained as separate data structures in storage. If the user desires to print fewer than all of the planes, the optical disc player prints the selected planes from the corresponding data structures. In some embodiments, the user may be able to choose from a variety of sizes, resolutions, and sources of the image rendering. For example, if the original still image provides higher resolution, the original photo file or any combination of graphics planes or other sources may be used for print generation.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
converting a still image to a video sequence;
providing said video sequence to a video plane; and
combining said video plane with at least one other plane to generate a signal to be provided to a display.

2. The method of claim 1 wherein said video sequence comprises a plurality of video frame images and said method further comprises implementing a visual effect on at least one video frame images in said video sequence.

3. The method of claim 1 wherein converting the still image to a video sequence occurs during playing of the still image.

4. The method of claim 1 wherein combining said video plane with at least one other plane comprises combining said video plane with a plane that provides a background for the video plane.

5. The method of claim 1 wherein combining said video plane with at least one other plane comprises combining said video plane with a plane that provides instructions.

6. The method of claim 1 wherein combining said video plane with at least one other plane comprises combining said video plane with a plane that provides metadata associated with said video sequence.

7. The method of claim 1 further comprising printing at least one of said video or other planes.

8. A method of viewing a file, comprising:
causing the file to begin playing; and
after causing the file to begin playing, converting a still image from the file into a plurality of video frames to form a video clip.

9. The method of claim 8 wherein converting the still image comprises replicating the still image into a plurality of video frames to form the video clip.

10. The method of claim 8 further comprising combining a plurality of graphics planes to form a video signal, at least one of said graphics planes comprising the video clip.

11. The method of claim 10 further comprising printing at least one of said graphics planes.

12. A system, comprising:
a frame replication module to convert each of a plurality of still images into a plurality of video frame images;
storage containing a plurality of graphics planes, one of said planes being provided with the plurality of video frame images.
a buffer that combines said graphics planes together to generate a signal to be provided to a display.

13. The system of claim 12 further comprising a print agent adapted to print from at least one of said graphics planes.

14. The system of claim 12 further comprising executable code that implements a visual effect on at least one video frame image from among said plurality of video frame images.

15. The system of claim 12 wherein at least one of said graphics planes contains information selected from at least one of the group consisting of metadata, navigational menus, and a background image.

16. The system of claim 12 wherein said frame replication module converts each of the plurality of still images during playing of a file containing said still images.

17. A storage medium containing software that, when executed by a processor, causes the processor to:
cause a file to begin playing; and
after causing the file to begin playing, to convert a still image from the file into a plurality of video frames to form a video clip.

18. The storage medium of claim 17 wherein, when executed by a processor, the software causes the processor to convert the still image by replicating the still image into a plurality of video frames to form the video clip.

19. The storage medium of claim 17 wherein, when executed by a processor, the software causes the processor to store said video clip as one of a plurality of graphics planes.

20. The storage medium of claim 19 wherein, when executed by a processor, the software causes the processor to initiate printing of at least one of said graphics planes.
